(19) United States
(12) Patent Application Publication
(10) Pub. No.: US 2014/0310158 A1
(43) Pub. Date: Oct. 16, 2014

(54) System and Method of Electronically Perfecting A Premium Finance Agreement

(71) Applicant: Michael R. Pappas, LaGrange, IL (US)

(72) Inventor: Michael R. Pappas, LaGrange, IL (US)

(73) Assignee: BRANCH BANKING AND TRUST COMPANY, Raleigh, NC (US)

(21) Appl. No.: 14/318,108

(22) Filed: Jun. 27, 2014

Related U.S. Application Data
(63) Continuation of application No. 11/690,893, filed on Mar. 26, 2007.

(51) Int. Cl. G06Q 40/02; G06Q 20/24

(52) U.S. Cl. CPC G06Q 40/025; G06Q 20/24
USPC 705/38

(57) ABSTRACT

A system and method of electronically perfecting a premium finance agreement (PFA) includes receiving data associated with an agent, the agent representing a potential insured; receiving data from the agent corresponding to at least a down payment for the PFA by the insured; providing the agent with the ability to electronically sign the PFA; and generating an email message to the insured, the email message corresponding with the PFA and the down payment. The system and method also include receiving bank account data associated with the insured; displaying a confirmation of the down payment amount that will be deducted from the bank account; providing a person authorized by the insured the ability to electronically sign the PFA; and electronically debiting the bank account for at least the down payment amount.

### RELATED APPLICATIONS

The present application is a continuation of and claims priority benefit of U.S. application Ser. No. 11/690,893 entitled “System and Method of Electronically Perfecting A Premium Finance Agreement” filed Mar. 26, 2007, the entirety of which is hereby incorporated herein by reference.

### FIELD OF THE INVENTION

The invention generally relates to a system for and method of electronically perfecting a Premium Finance Agreement (PFA).

### BACKGROUND

Business entities that offer premium financing to businesses and individuals frequently utilize agents, brokers, or other similar business partners to work with and interact directly with the businesses and individuals. Traditionally, after completing a quote for premium financing, the agent completes, prints and forwards the agreement via fax or U.S. Mail to the insured business or person for written signature. The insured then signs the agreement and sends it back to the agent/broker for countersignature. The insured is also typically required to include a check for a down payment amount. Once duly signed, the agreement is sent to the premium financing entity for processing. This procedure is very inefficient and typically takes days or weeks to complete. Additionally, it is difficult for any of the parties involved in the process to know the current status of the application or to know how far the application has progressed in the overall process.

### SUMMARY OF THE INVENTION

The claimed method and system provides for electronically perfecting a premium finance agreement (PFA) that includes receiving data associated with an agent, the agent representing a potential insured; receiving data from the agent corresponding to at least a down payment for the PFA by the insured; providing the agent with the ability to electronically sign the PFA; and generating an email message to the insured, the email message corresponding with the PFA and the down payment. The system and method also include receiving bank account data associated with the insured; displaying a confirmation of the down payment amount that will be deducted from the bank account; providing a person authorized by the insured the ability to electronically sign the PFA; and electronically debiting the bank account for at least the down payment amount.

### BRIEF DESCRIPTION OF THE DRAWINGS

FIGS. 1, 2, and 3 illustrate block diagrams of a computing system that may operate in accordance with the described embodiments;

FIGS. 4A and 4B illustrate portions of a flowchart representing an exemplary embodiment of a method of electronically perfecting a premium finance agreement based on interactions with an agent;

FIGS. 5A-5B illustrate portions of a flowchart representing an exemplary embodiment of a method of electronically perfecting a premium finance agreement based on interactions with an insured;

FIGS. 6-25 illustrate exemplary embodiments of screenshots that may be used in a method of perfecting a premium finance agreement.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

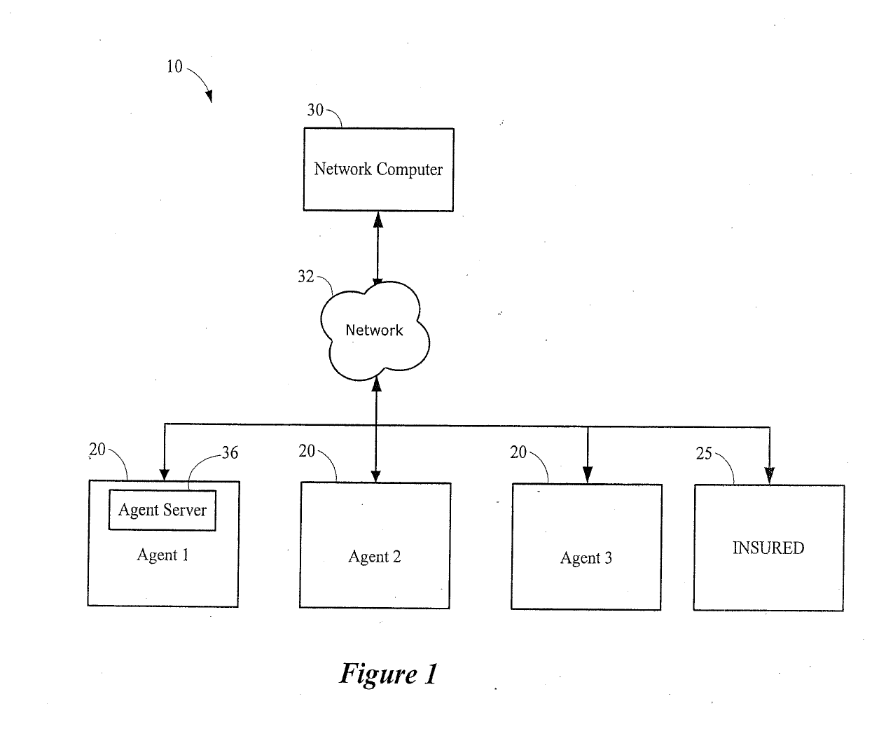

FIG. 1 illustrates an embodiment of a data network 10 including a first group of agents 20 operatively coupled to a network computer 30 via a network 32. The plurality of agents 20 may be located, by way of example rather than limitation, in separate geographic locations from each other, in different areas of the same city, or in different states. As used herein, the term “agent” is intended to be interpreted it in its broadest sense and to include all types of agents, brokers, or other business partners. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download quotation data as well as data corresponding to premium finance agreements (PFAs). For example, the network computer 30 may periodically receive data from each of the agents 20 indicative of information pertaining to costs and terms of particular quotations and PFAs. The agents 20 may utilize at their offices one or more agent servers 36 that may be utilized to store information for a plurality of insureds associated with each agent.

Although the data network 10 is shown to include one network computer 30 and three agents 20, it should be understood that different numbers of computers and agents may be utilized. For example, the network 32 may include a plurality of network computers 30 and hundreds of agents 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating PFA data.

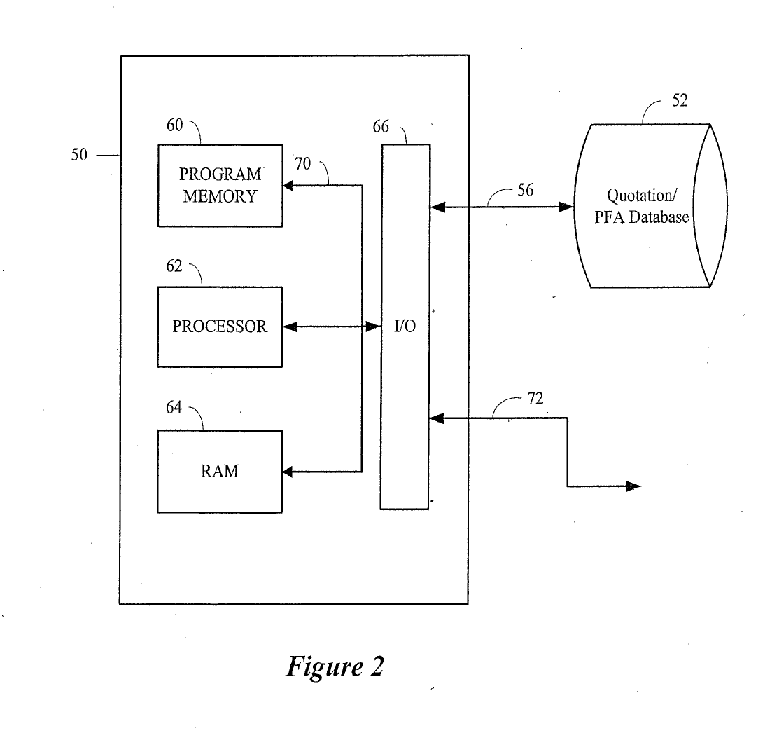

FIG. 2 is a schematic diagram of one possible embodiment of the network computer 30 shown in FIG. 1. The network computer 30 may have a controller 50—that is operatively connected to a database 52 via a link 56. It should be noted that, while not shown, additional databases may be linked to the controller 50 in a known manner.

The controller 50 may include a program memory 60, a processor 62 (may be called a microcontroller or a microprocessor), a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. All of these memories or data repositories may be referred to as machine-accessible mediums. The controller 50 may also be operatively connected to the network 32 via a link 72.

For the purpose of this description and as briefly discussed above, a machine-accessible medium includes any mechanism that provides (i.e., stores and/or transmits) information in a form accessible by a machine (e.g., a computer, network device, personal digital assistant, manufacturing tool, any device with a set of one or more processors). For example, a machine-accessible medium includes recordable/non-recordable media (e.g.; read only memory (ROM); random access memory (RAM); magnetic disk storage media; optical storage media; flash memory devices), as well as electrical, optical, acoustical or other form of propagated signals (e.g., carrier waves, infrared signals, digital signals); etc.

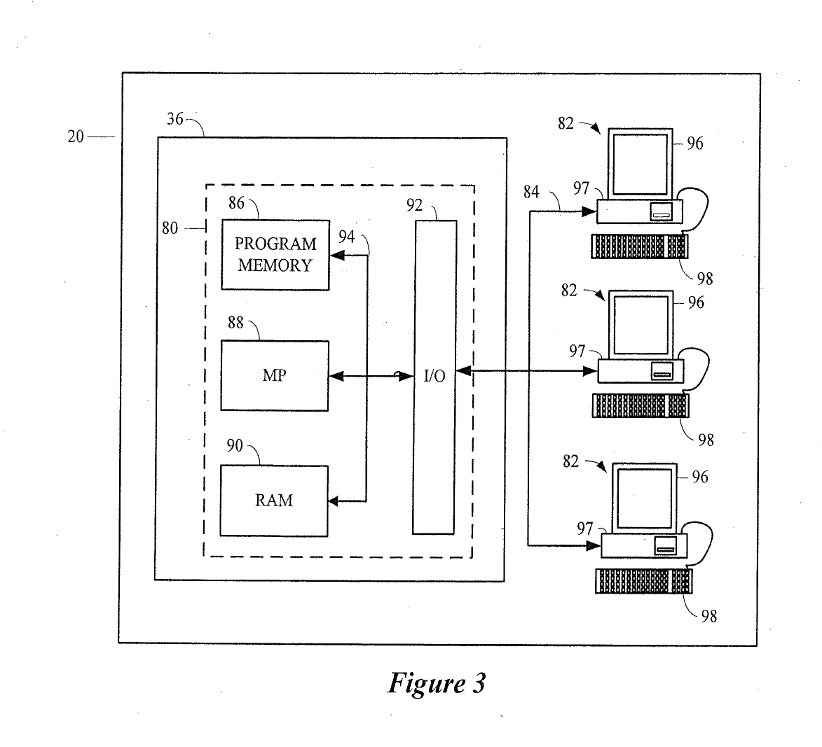

FIG. 3 is a schematic diagram of one possible embodiment of several components located at one or more of the agents' businesses 20 from FIG. 1. Although the following description addresses the design of the agents' businesses 20, it should be understood that the design of one or more of the agent's business 20 may be different than the design of other agent's business 20. Also, each agent 20 may have various different structures and methods of operation. It should also be understood that the embodiment shown in FIG. 3A illustrates some of the components and data connections present in an agent's business, however it does not illustrate all of the data connections present in a typical business. For exemplary purposes, one design of an agent's business is described below, but it should be understood that numerous other designs may be utilized.

The agent 20 may have an agent server 36, which includes a controller 80, wherein the agent server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a scanner, printer, mouse, touch screen, track pad, track ball, isopoint, voice recognition system, digital camera, etc. Each client device terminal 82 may be signed onto and occupied by an employee to assist them in performing their duties or by an insured to complete a financing service. Employees and/or insureds may sign onto a client device terminal 82 using any generically available technique, such as entering a user name and password. If an employee is required to sign onto a client device terminal 82, this information may be passed via the link 84 to the agent server 36, so that the controller 80 will be able to identify which employees are signed onto the system and which client device terminals 82 the employees are signed onto. This may be useful in monitoring the employees' productivity. If an insured signs onto a client device terminal, the insured may be assigned a username and password that may be used to record usage data and/or payment data.

Typically, agent servers 36 store a plurality of files, programs, and other data for use by the client device terminals 82 and the network computer 30. One agent server 36 may handle requests for data from a large number of client device terminals 82. Accordingly, each agent server 36 may typically comprise a high end computer with a large storage capacity, one or more fast microprocessors, and one or more high speed network connections. Conversely, relative to a typical agent server 36, each client device terminal 82 may typically include less storage capacity, a single microprocessor, and a single network connection.

FIG. 1 also illustrates an insured 25 may directly access the data network 10. The insured 25 may be directly coupled to the network 32 or, alternatively, may be a client device terminal coupled to an agent server 36. The insured 25 may utilize a computer that includes a display 96, a controller .97, a keyboard 98 as well as a variety of other input/output devices such as a scanner, credit card reader, printer, mouse, touch screen, track pad, track ball, isopoint, voice recognition system, digital camera, electronic storage device reader (e.g., flash drive interface or magnetic media reader), etc.

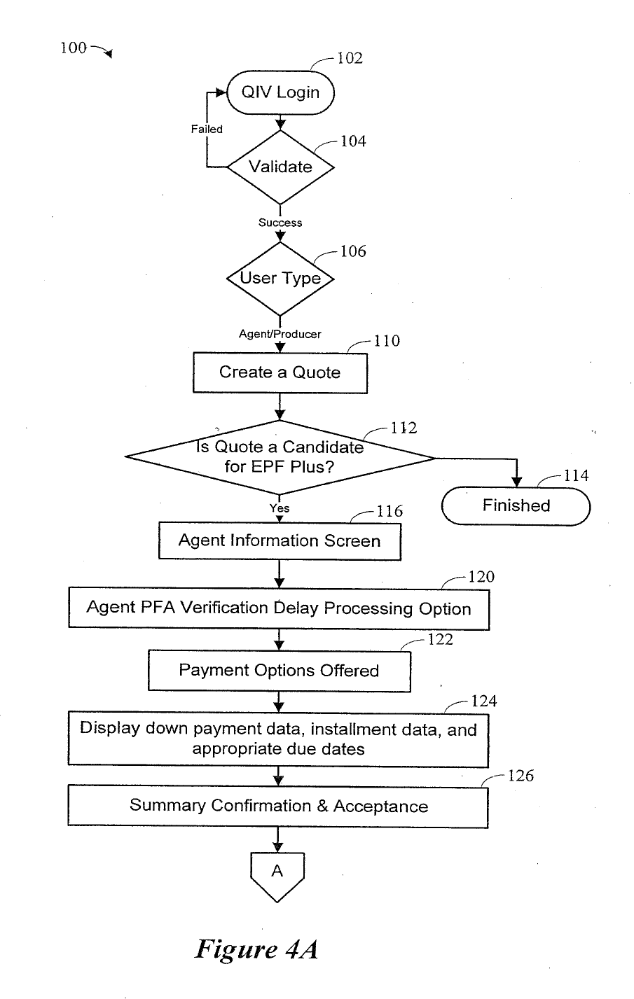

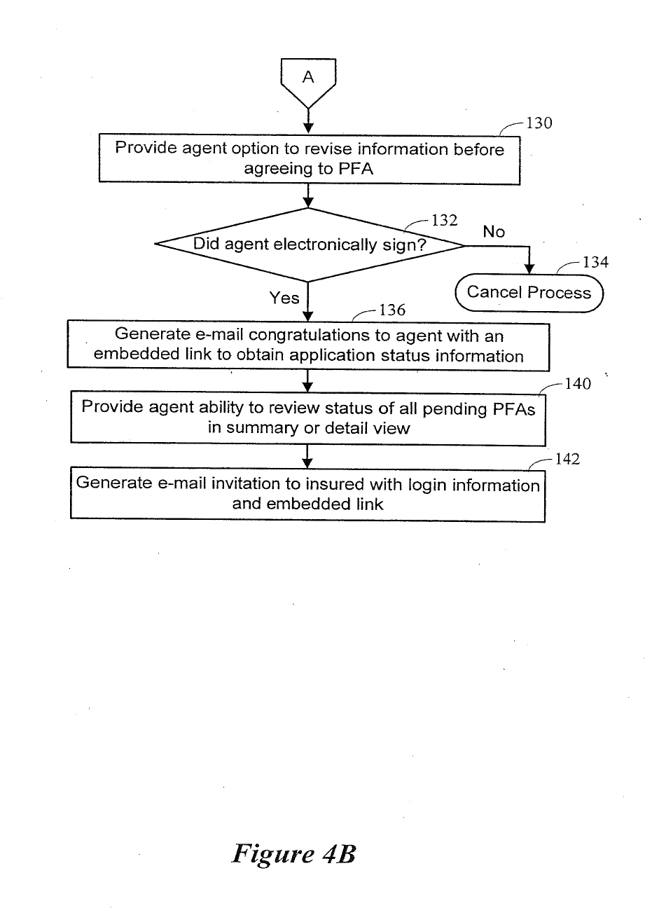

FIGS. 4A and 4B illustrate portions of a flowchart 100 representing an exemplary embodiment of a method of electronically perfecting a premium finance agreement based on interactions with an agent. This process may be implemented by any one of the computers illustrated in FIGS. 1-3. The computers may execute program instructions that are adapted to perform the methods of FIGS. 4A and 4B.

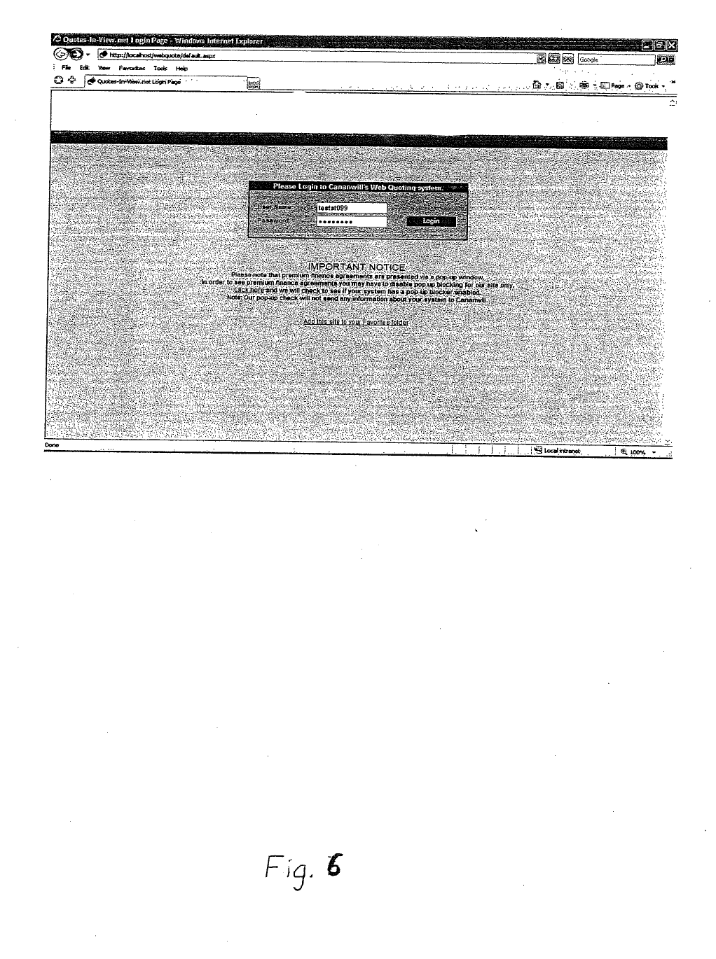

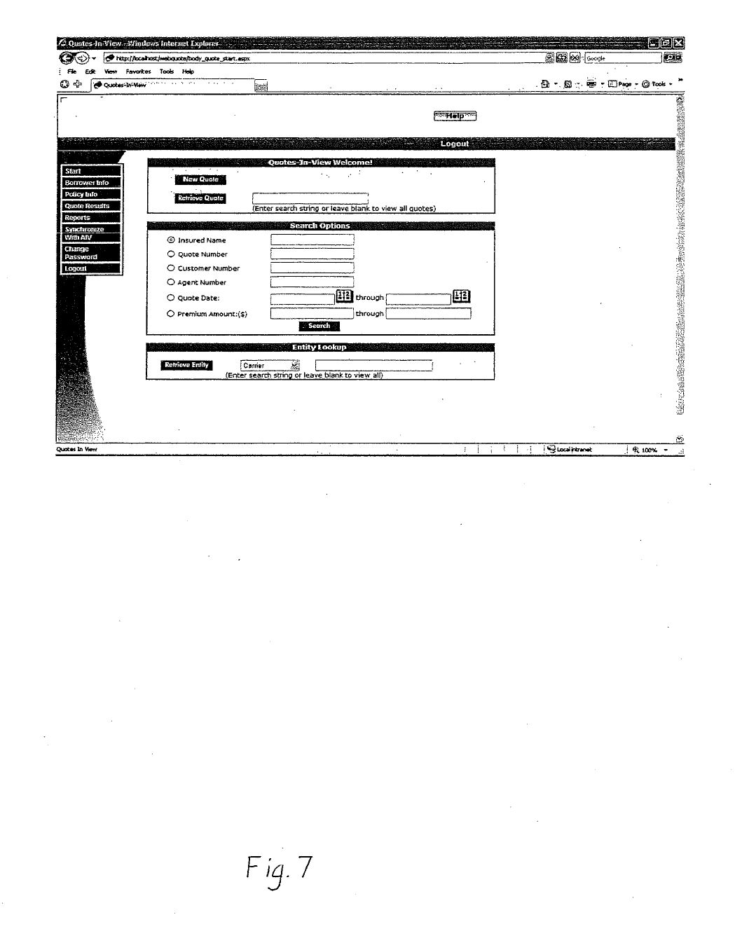

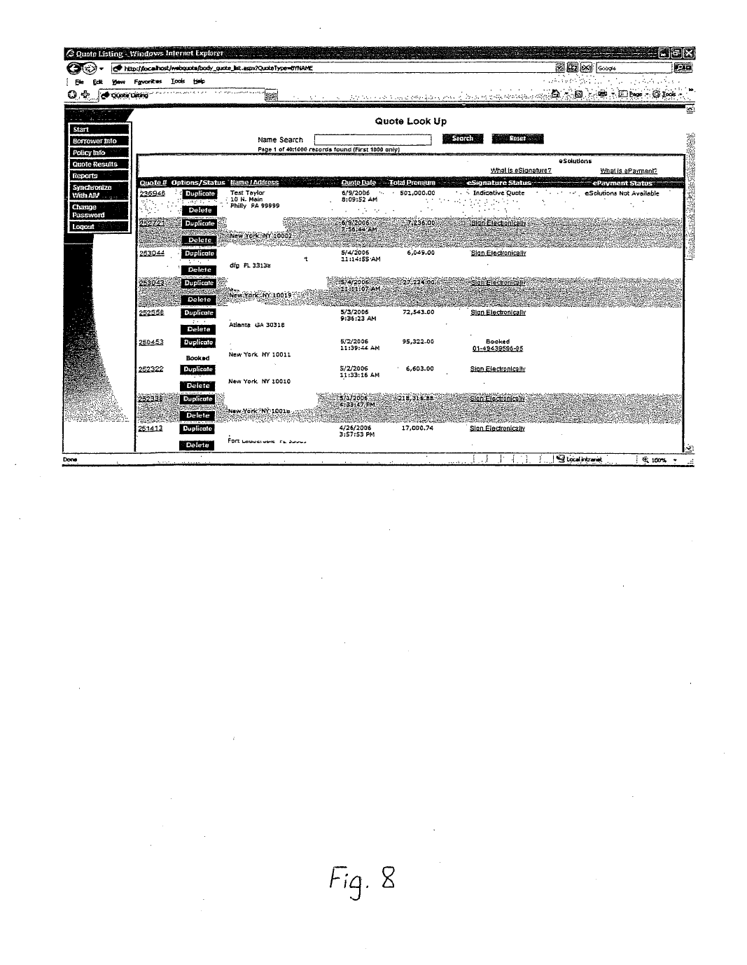

The method 100 may begin when an agent or other user logs in to a quoting system to provide quotations for premium finance agreements (block 102). The quoting system may be a secured system and may require the agent to enter a username and password as illustrated in FIG. 6. As noted below, those of ordinary skill in the art will readily recognize that points of entry other than a quoting system may be utilized to provide access to the premium financing entity's system. The quoting system may validate the agent (block 104) and proceed to determine the user type (block 106). The agent may then create a new quote (block 110) for a premium finance agreement (PFA) for an insured that the agent has a relationship with, or select an existing quote that has already been entered into the system in one of several different ways. As illustrated in FIG. 7 the agent may search for an existing quotation based on, for example, the insured name, a quotation number, a customer number, an agent number, a date range for a quotation, or a premium amount range. If the agent initiates a search for an existing quote, a number of existing records satisfying the search requirements may be displayed to the agent, as illustrated in FIG. 8.

The search results may be displayed to an agent using a graphical user interface that also displays a status of a PFA to provide an indication to the agent as to whether or not the PFA has been electronically signed by the insured. If the PFA has been electronically signed by the insured, the record will indicate that the PFA has been “booked” and may also include a reference number corresponding to a perfected PFA. The agent may also be displayed information associated with payment data at for a particular PFA. This will provide a good summary or overview to the agent of the status of matters corresponding to a number of PFAs.

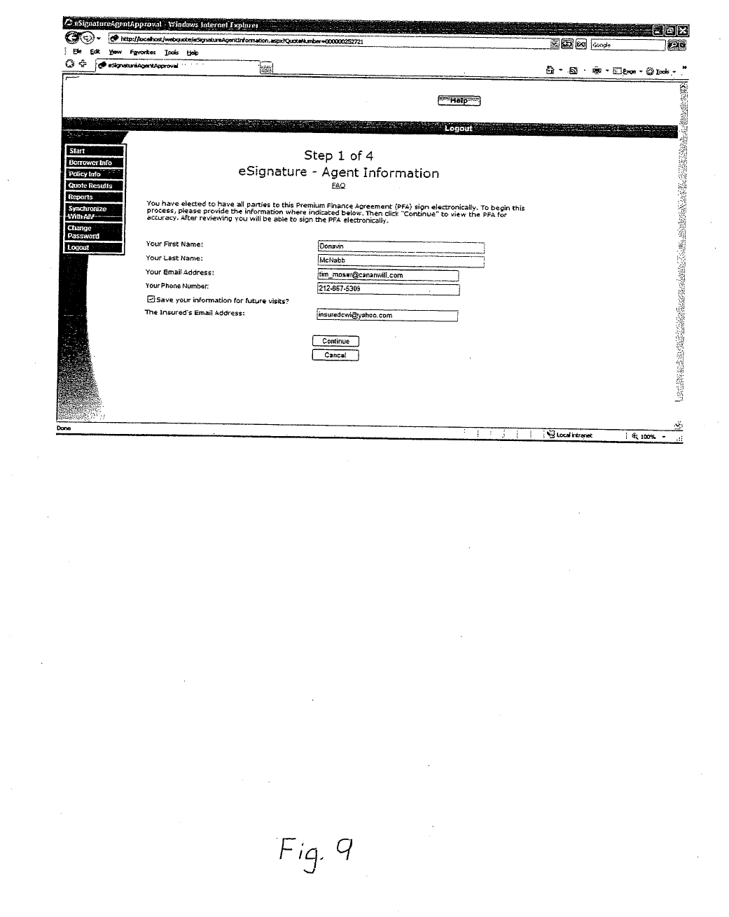

The method 100 may then determined if the quotation is a candidate for further electronic processing (block 112) that may include electronically signing the PFA and possibly arranging an electronic payment for a down payment for the PFA and/or recurring installments for the PFA by the insured. If it is determined at the block 112 that the quote is not a candidate for further electronic processing, or if the agent simply does not want to participate in the further electronic processing of the PFA, the method 100 may be completed (block 114). If it is determined at the block 112 that the quote was a candidate for the electronic processing, and the agent chooses to continue with the electronic processing, the agent may be displayed an agent information screen which may be pre-populated with data retrieved from a database that corresponds to the agent, or it may require the agent to enter in to the system personal data associated with the agent (block 116). This information may also include information, such as, for example, the insured's e-mail address, as illustrated in FIG. 9. Those of ordinary skill in the art. will readily recognize that this disclosed method 100 for electronically perfecting a premium finance agreement may not require the use of, or the direct linking of, a quotation system and need only require that the premium financing entity receive data associated with the agent representing the potential insured. It should also be noted that the data may alternatively come from a third-party business having a business relationship with the agent.

As further illustrated in FIG. 9, the system may provide a box that the agent may check to save his or her information for future visits, which could allow the system to skip this step and automatically retrieve the agent's personal information.

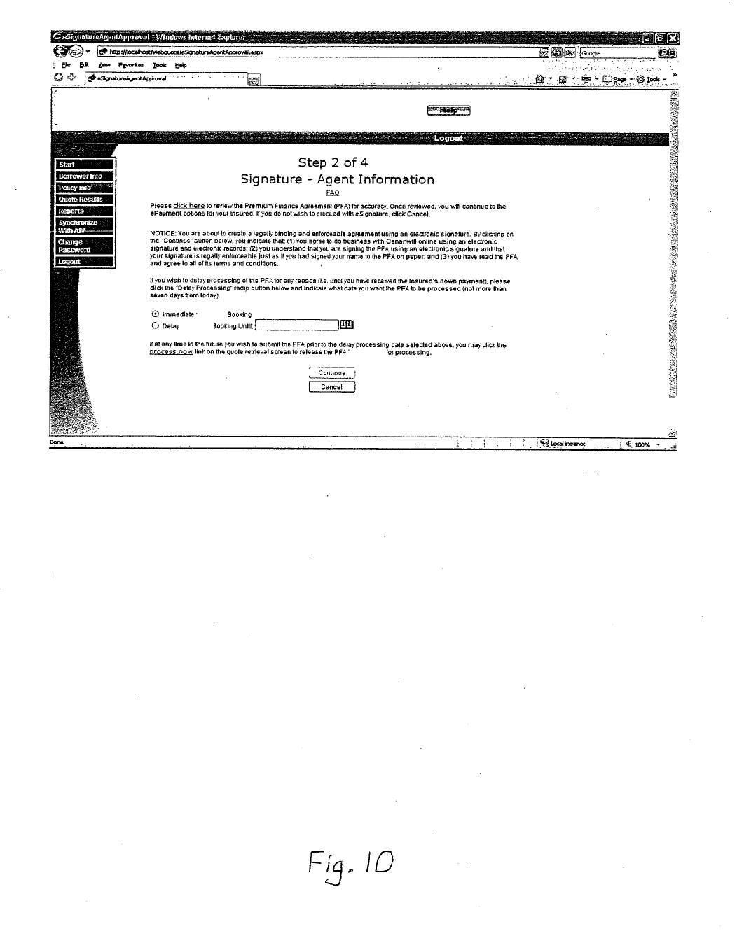

The method 100 may then display a screen to the agent as illustrated in FIG. 10. The method 100 may generate a link to a PDF image of the premium finance agreement for review by the agent. The method 100 may be configured to only allow the agent to continue after the agent has reviewed the PDF of the premium finance agreement (block 120). As further illustrated in FIG. 10, the method 100 may also provide the ability for the agent to delay processing of the premium finance agreement for any reason, such as, for example, until after the agent has received the insured's down payment. If the agent selects the option to delay booking of the premium finance agreement, the agent is also provided with the ability to enter a future date that the agent wants the premium finance agreement to be processed. Those of ordinary skill in the art will readily appreciate that this step could be eliminated at the request of the agent to further streamline the application process.

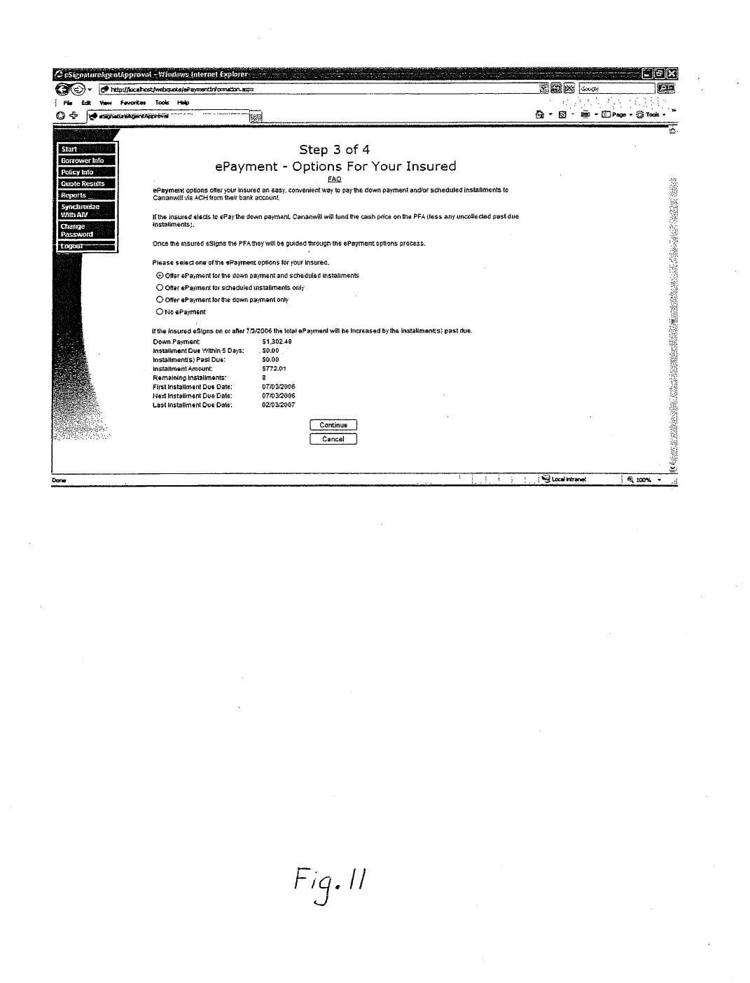

Still referring to FIG. 4A, the method 100 may then display a screen to the agent, such as the exemplary screen illustrated in FIG. 11, to provide the agent with a number of different payment options that may be offered to the insured (block 122). These options offer the insured an easy, convenient way to pay the down payment and/or schedule installments to the financing entity via ACH from their bank account. If the insured elects to electronically pay the down payment, the financing entity will fund the cash price on the premium finance agreement, less any uncollected past-due installments. Examples of electronic payment options for the insured may include, for example, an option for electronic payment of a down payment for the premium finance agreement by the insured, an option for an electronic payment of scheduled installments for the premium finance agreement, and an option for electronic payment of both a down payment for the premium finance agreement and scheduled installments for the premium finance agreement. As further illustrated in FIG. 11, the method 100 may also include retrieving from the quotation database, or any other linked database, information associated with the premium finance agreement (block 124). This information may include, for example, a down payment amount, installments due within a predetermined number of days, installment past-due amounts, an installment amount, a remaining number of installments, a first installment due date, next installment due date, last installment due date, etc. It should also be noted that the method 100 may allow an agent to pick one of the options as their standard default so that they may quickly and efficiently skip this step.

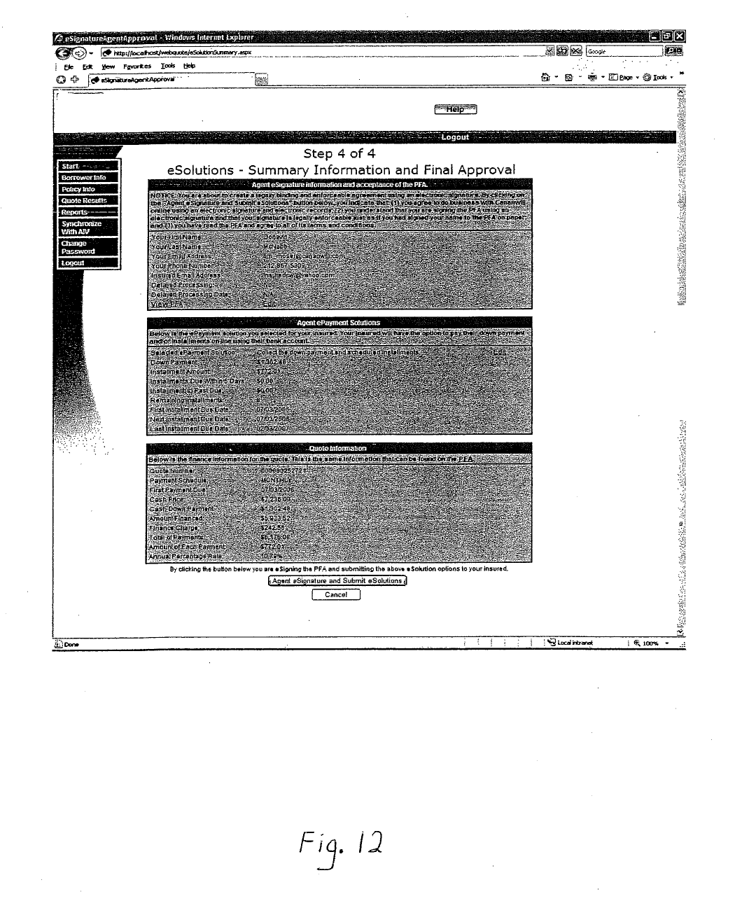

After the system has received data from the agent corresponding to a selected payment option, the system may display summary information and final approval data to the agent corresponding to the premium finance agreement (block 126). An exemplary illustration of this is shown in FIG. 12. The screen illustrated in FIG. 12 may include a link to a PDF image of the premium finance agreement as well as providing the agent with the ability to edit any information previously entered and displayed in a summary information screen (block 130, FIG. 4B). The system may also notify the agent that they are about to create a legally binding and enforceable agreement using an electronic signature. By clicking on a specific button, the agent agrees to do business with the financing entity using an electronic signature and electronic records, thus providing consent that they understand that they are signing the premium finance agreement using an electronic signature and that the signature is legally enforceable, just as if the agent had signed his or her name to the premium finance agreement on paper. The agent may also be required to confirm that they have read the premium finance agreement and agree to all of its terms and conditions. As further illustrated in FIG. 12, the agent may be displayed all of the electronic payment options that the agent selected for the insured, which may include their down payment and/or installments. The summary information may also include data corresponding to the initial finance information associated with the quotation for the insured.

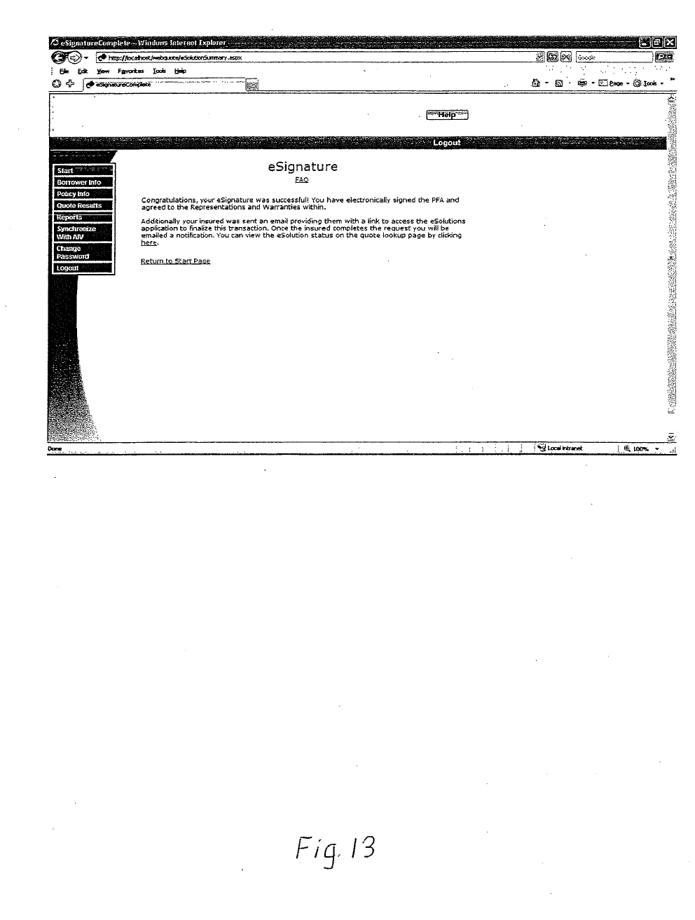

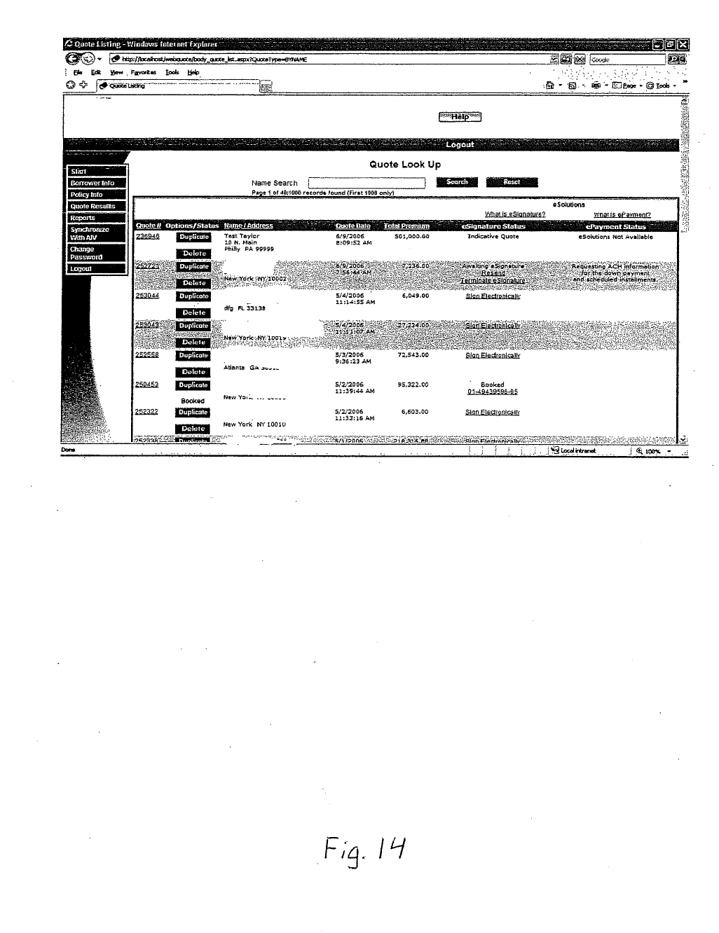

Referring to FIG. 4B, the method 100 may include providing the agent with the ability to electronically sign the premium finance agreement. The method 100 may then determine if the agent electronically signed the premium finance agreement (block 132). If it is determined at the block 132 that the agent did not electronically sign the premium finance agreement, the process will be canceled (block 134). If it is determined at the block 132 that the agent electronically signed the premium finance agreement, the method 100 will generate an e-mail message to the agent congratulating the agent and informing the agent that the electronic signature was successful (block 136). An exemplary e-mail message is illustrated in FIG. 13. The e-mail message may inform the agent that they not only signed the premium finance agreement but that they also agreed to the representations and warranties therewithin. The e-mail message may also inform the agent that an e-mail was sent to the insured providing them with a link to access the premium finance agreement application in order to finalize the transaction. The e-mail message sent to the agent may also include an embedded link to allow the agent to obtain application status information. If the agent clicks on this link, they will be taken to a list of all pending premium finance agreements associated with the agent to allow the agent to view the status of their pending premium finance agreements in one of several view formats, including a summary view or a detailed view (block 140).

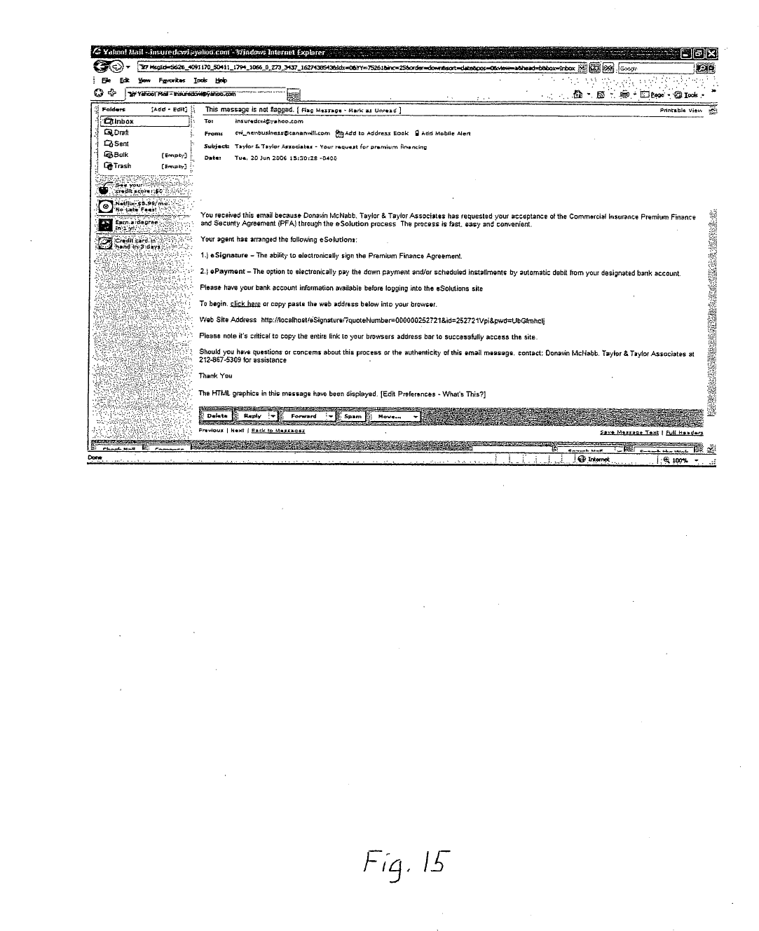

After determining that the agent electronically signed the premium finance agreement, the method 100 may also generate an e-mail message to the insured, wherein the e-mail message includes data to facilitate the insured in accessing an entity offering the premium finance agreement (block 142). As illustrated in FIG. 15, the e-mail message sent to the insured may include login information and an embedded link. The e-mail message sent to the insured will notify the insured that they were sent the e-mail message at the request of the agent and request their acceptance of the premium finance agreement through the electronic signature process. The e-mail message may also include corresponding finance data that would be based on the payment options selected by the agent earlier in the process. It should be noted that if the agent did not select any of the possible payment options for the insured, then the e-mail message would only include information relating to a request for the insured to electronically sign the premium finance agreement.

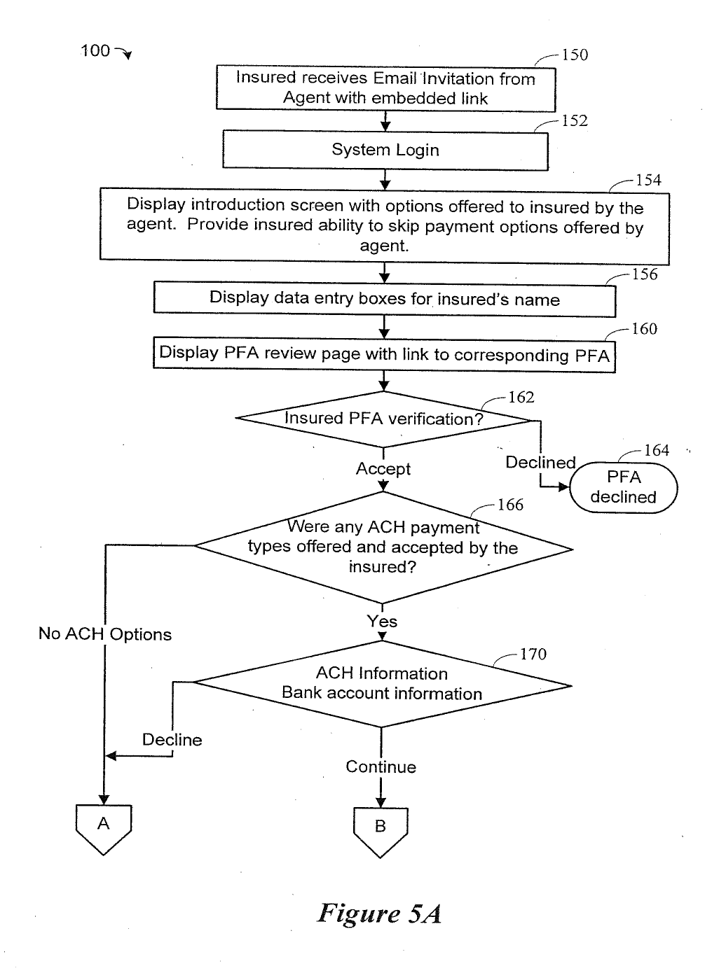

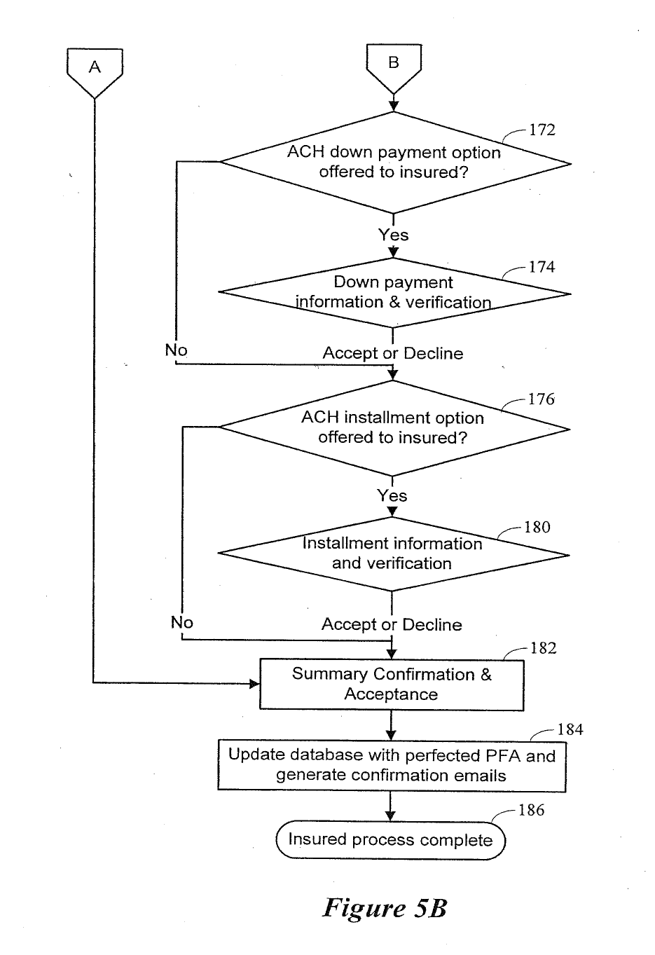

FIG. 5A illustrates an exemplary second portion of the flowchart 100 that deals primarily with the insured. After the insured receives the e-mail invitation from the financing entity with the embedded link (block 150), the insured may then begin the login process (block 152). This maker when the insured clicks on the embedded link or copies a web site address into a Web browser to effectuate the transfer to the financing entity or any server associated with the financing entity.

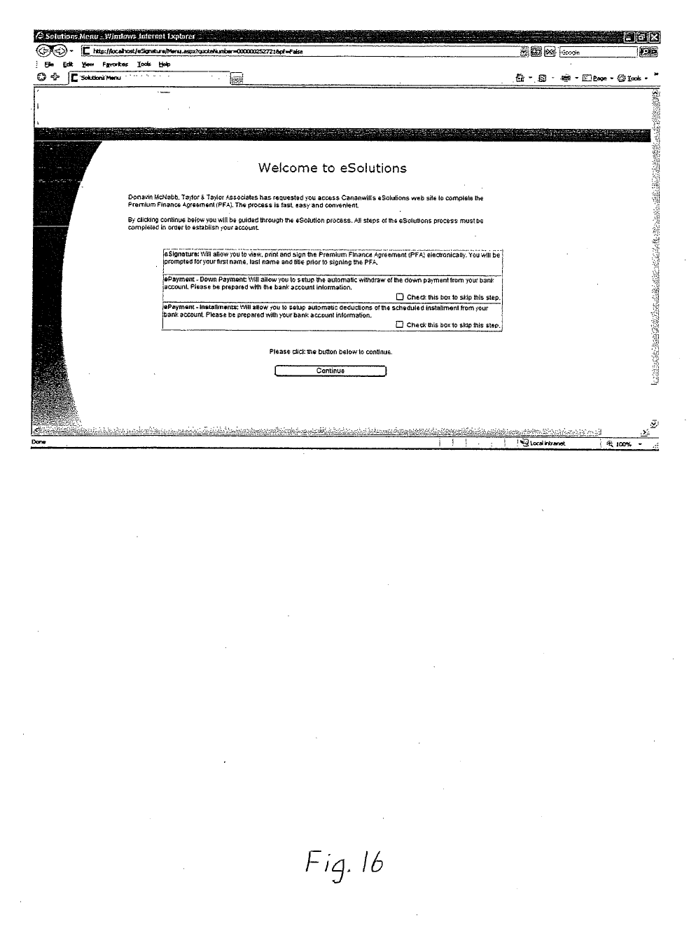

The method 100 then displays to the insured an introduction screen with options offered to the insured that correspond to the selected payment options selected by the agent (block 154). An exemplary introduction or welcome screen is illustrated in FIG. 16. The introduction screen may provide the insured with the ability to a opt out of or skip payment options offered by the agent, thus allowing the insured to tailor the premium finance agreement to their individual preferences. The payment options listed on the screen may simply be summaries of the options, or they may include more detailed information about each of the payment options.

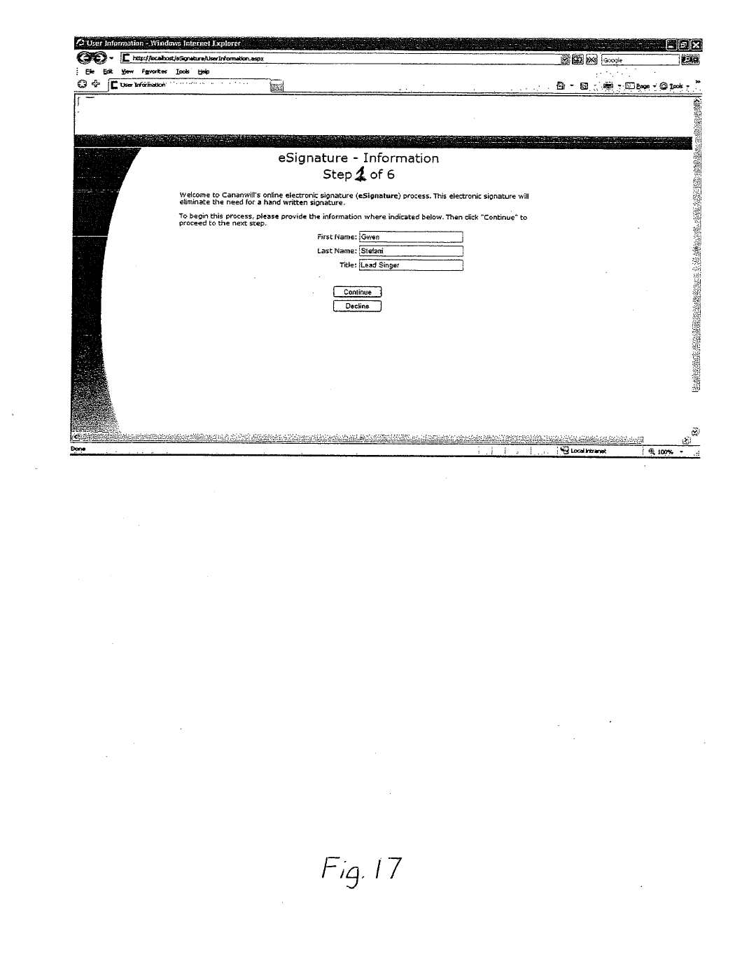

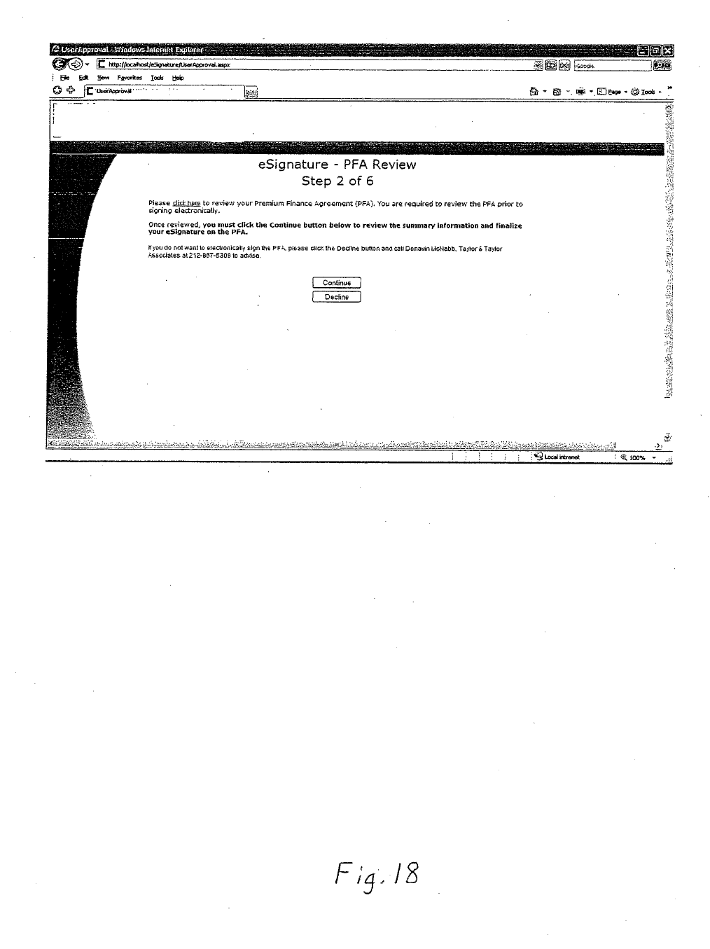

After the data corresponding to the selected payment options has been displayed to the insured, and after receiving indication that the insured wishes to continue with the electronic signature process, the method 100 may display data entry boxes to allow for the entry of the name and title of the person electronically signing the premium finance agreement (block 156). This person may or may not be the actual insured. An exemplary screen illustrating this step is illustrated in FIG. 17.

After receiving data associated with the name of the person electronically signing the premium finance agreement on behalf of the insured, the method 100 may display a premium finance review page with a link to the corresponding premium finance agreement (block 160). The person is thus required to review the premium finance agreement prior to signing electronically.

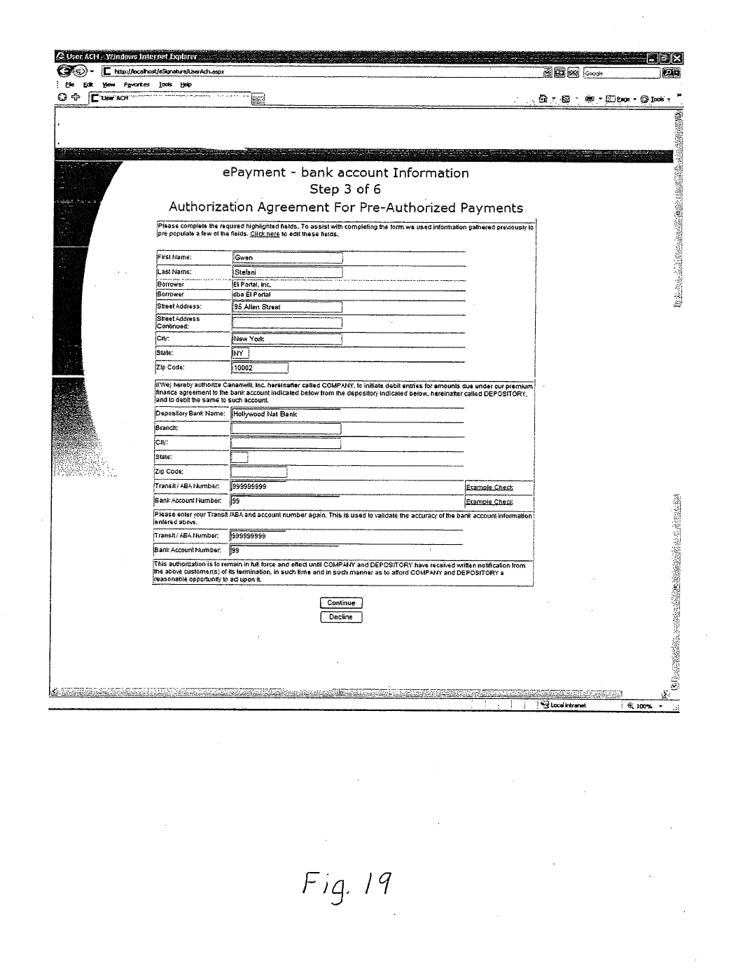

The method 100 may then verify whether or not the person signing the premium finance agreement reviewed the premium finance agreement (block 162). The ability to decline the premium finance agreement is provided throughout the process for convenience to the person signing the premium finance agreement (block 164). If it is determined at the block 162 that the person signing the premium finance agreement reviewed the premium finance agreement and wanted to continue, the method 100 may then determine if there were any ACH payment types offered and accepted by the person signing the premium finance agreement (block 166). If it is determined at the block 166 that ACH payment types were accepted, the method 100 may prompt the person signing the PFA to input bank account data, wherein the bank account data corresponds to a bank account that will be debited for at least the down payment for the premium finance agreement (block 170). An exemplary screen illustrating a form to input such data is illustrated in FIG. 19. The bank account data may include a bank name, a transit/ABA Number, as well as a bank account number. While not required, the ABA Number and bank account number may be pinged to a web site that is an extension of the Federal Reserve to check to ensure that the routing number is valid.

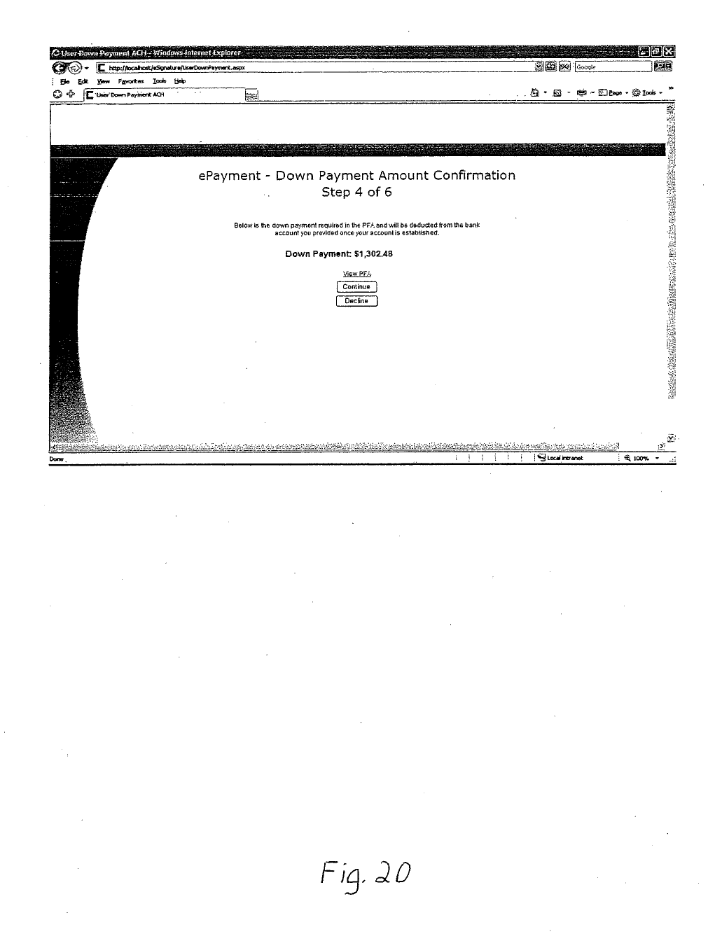

FIG. 5B illustrates that if it is determined at a block 172 that an ACH down payment option has been offered to the insured and accepted, the method 100 may then display to the person signing the premium finance agreement a down payment amount confirmation that includes the down payment amount that will be deducted from the bank account provided, once the account is established. An example of this is illustrated in FIG. 20. If it is determined at a block 174 that the down payment information has been verified, the system may determine if an ACH installment option was offered to the insured (block 176).

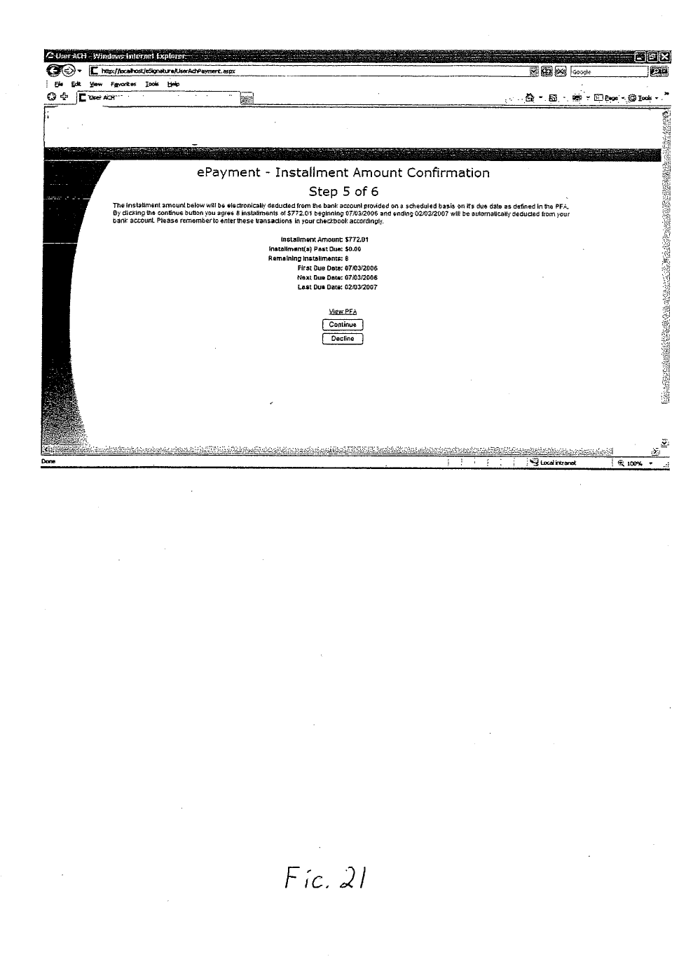

If it is determined at the block 176 that an ACH installment option was offered to the insured, the system may display to the person signing the premium finance agreement an installment amount confirmation screen. An example of the screen is illustrated in FIG. 21. This confirmation screen may inform the person signing the premium finance agreement that the installment amount shown will be electronically deducted from the bank account provided on a scheduled basis on its due date is defined in the premium finance agreement and the confirmation screen may include, for example, the installment amount, any installments past due, the number of remaining installments, the first due date for an installment, the next due date for an installment, and the last due date for installment. A link to view an image of the premium finance agreement may also be included. If it was determined at the block 176 that no ACH installment options were offered to the insured or accepted by the person signing the premium finance agreement, system would not display the installment confirmation screen.

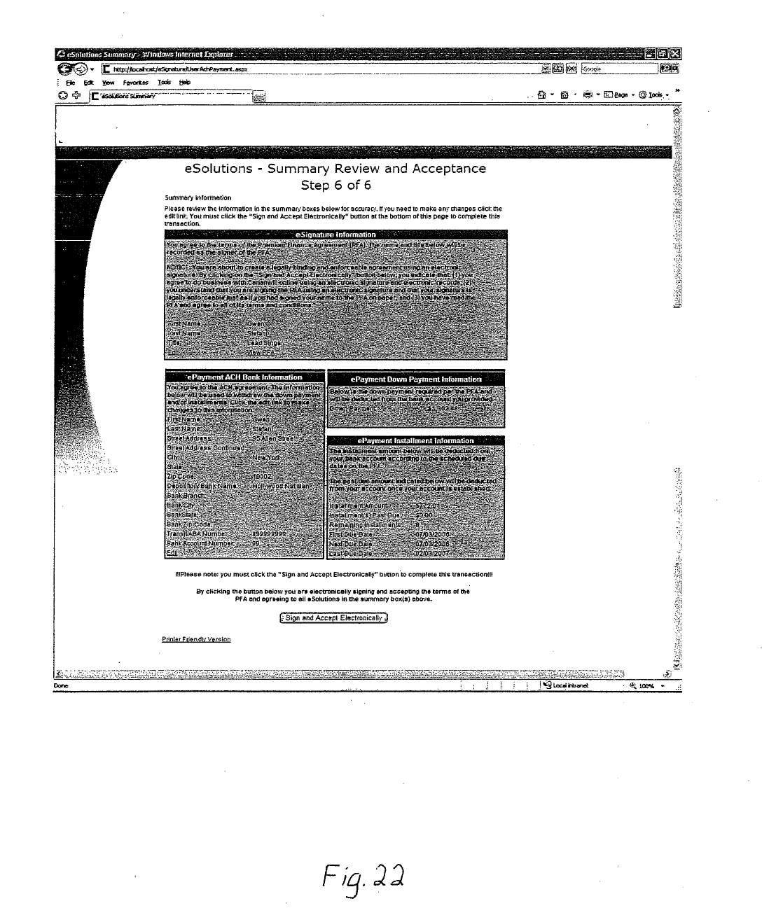

After displaying the installment confirmation screen, the method 100 may then verify that the person signing the premium finance agreement verified the data displayed in the installment confirmation screen and chose to continue with the process (block 180), Thereafter, the method 100 may display a summary review and acceptance screen (block 182). It should also be noted that if it was determined at the block 166 in FIG. 5A that no ACH options were offered to the insured or that the person signing the premium finance agreement did not accept any ACH payment types, the method 100 would also proceed to display the summary confirmation and acceptance screen. An example of such a screen is illustrated in FIG. 22. This summary review and acceptance screen may include a link to allow viewing of the premium finance agreement as well as editing of any of the data previously entered. The method 100 could prevent the editing of the down payment amount, installment amount, and any of the due dates, for example. The screen also provides the person signing the premium finance agreement with the ability to electronically sign the premium finance agreement.

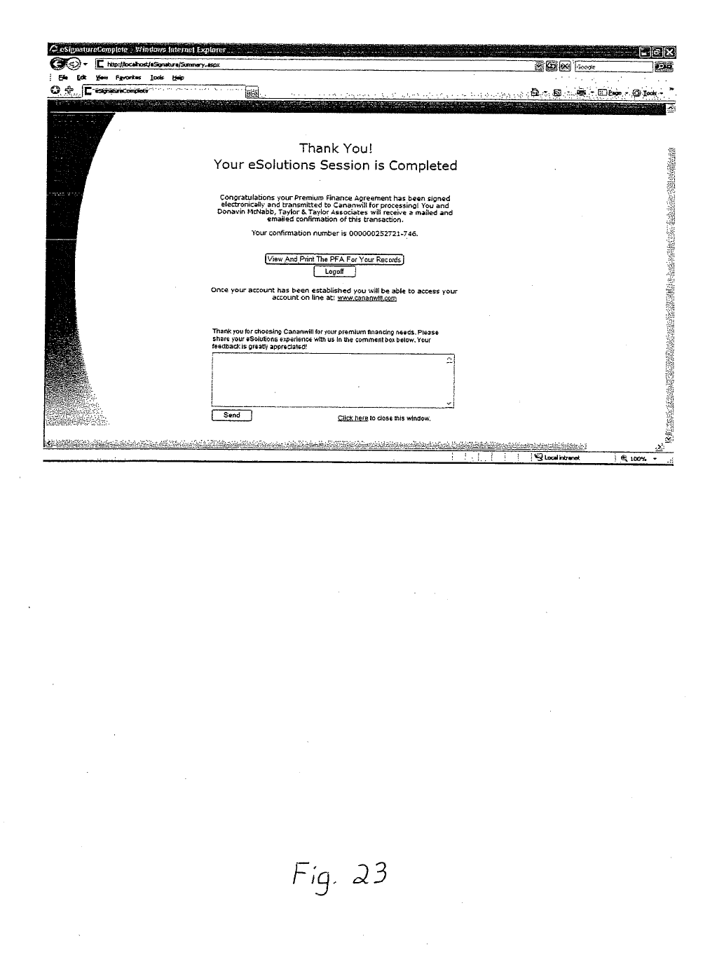

The method 100 may then determine if the person signing the premium finance agreement electronically signed the premium finance agreement. If it is determined that the premium finance agreement was electronically signed, a screen may be displayed to the person signing the premium finance agreement congratulating the person and indicating that the premium finance agreement was signed electronically and transmitted to the financing entity for processing. A confirmation number may also be generated and provided to the person that signed the premium finance agreement. An exemplary screen illustrating this is shown in FIG. 23. The user may also be provided with the ability to view and print the premium finance agreement for their records.

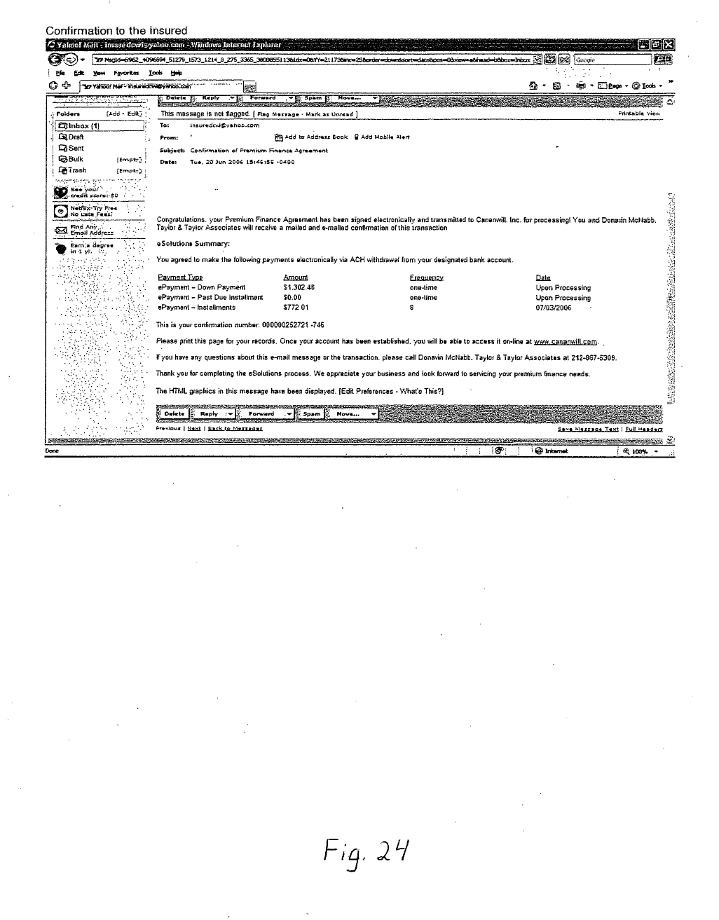

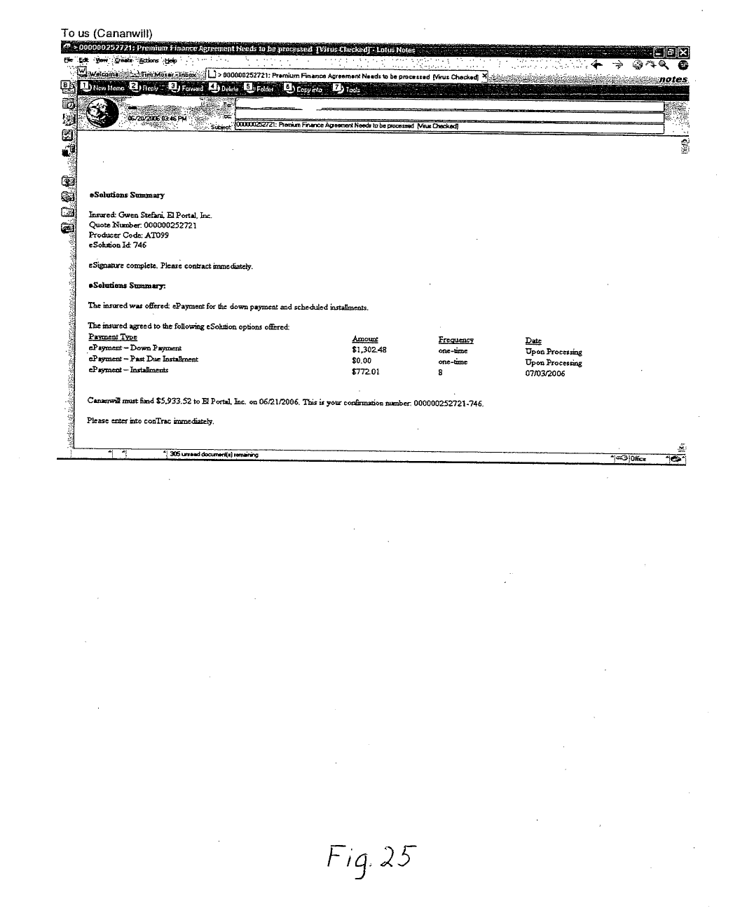

The premium financing entity's database will then be updated with the perfected premium finance agreement and a number of confirmation e-mails may be generated and transmitted (block 184). For example, an e-mail notifying the person signing the premium finance agreement and/or insured may be generated to notify them that the premium finance agreement has been perfected or completed. An example of such an e-mail is illustrated in FIG. 24. As illustrated, the e-mail may include the date that the premium finance agreement was completed for processing as well as providing data corresponding to the down payment and scheduled installments, if such data is appropriate. The e-mail message may also include a confirmation number associated with the perfected premium finance agreement. The method 100 may further generate an e-mail congratulations to the agent with an embedded link to facilitate the agent in obtaining status information associated with the premium finance agreement. The premium finance agreement is thus perfected (block 186).

After electronically debiting the bank account for either the down payment amount or installment amount, when appropriate, the premium financing entity may also automatically generate e-mail payment reminders to the insured to remind the insured of a remaining installment payment.

Although the technique for perfecting a premium finance agreement, as described herein, is preferably implemented in software, it may be implemented in hardware, firmware, etc., and may be implemented by any other processor associated with the insurance business and other facilities. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

The invention has been described in terms of several preferred embodiments. It will be appreciated that the invention may otherwise be embodied without departing from the fair scope of the invention defined by the following claims.

We claim:

1. A non-transitory machine-readable medium having stored thereon a plurality of executable instructions to:
provide access to a premium finance agreement (“PFA”) on a first computer system of a premium financing entity before the PFA has been perfected;
receive at the first computer data from an agent representing a potential insured, wherein the data corresponds to at least a down payment for the PFA by the insured;
receive at the first computer an electronic signature for the PFA from the agent;
generate at the first computer an email message to the insured, wherein the e-mail message provides the insured with access to the PFA on the computer system of the premium financing entity before the PFA has been perfected;
receive at the first computer bank account data associated with the insured, wherein the bank account data corresponds to a bank account that will be debited for at least the down payment for the PFA;
display at a second computer a confirmation of the down payment amount that will be deducted from the bank account;
receive at the first computer an electronic signature from a person authorized by the insured to electronically sign the PFA; and
electronically debit the bank account for at least the down payment amount.

2. The non-transitory machine-readable medium of claim 1, further comprising executable instructions to determine whether the authorized person electronically signed the PFA; and generate at the first computer an email to notify the insured that the PFA has been completed if it is determined that the authorized person electronically signed the PFA.

3. The non-transitory machine-readable medium of claim 1, further comprising executable instructions to display at a third computer a plurality of electronic payment options for the PFA to the agent, wherein the plurality of payment options includes at least an option for electronic payment of a down payment for the PFA by the insured, and option for electronic payment of scheduled installments for the PFA, and an option for electronic payment of both a down payment for the PFA and scheduled installments for the PFA; and receiving data from the agent corresponding to a selected payment option.

4. The non-transitory machine-readable medium of claim 3, further comprising executable instructions to display at the third computer the down payment amount, a recurring installment amount, a number or remaining installments, and a first installment due date, when the agent selects the option for electronic payment of both the down payment for the PFA and the scheduled installments for the PFA.

5. The non-transitory machine-readable medium of claim 4, further comprising executable instructions to automatically generate at the first computer an email payment reminder to remind the insured of a remaining installment payment.

6. The non-transitory machine-readable medium of claim 4, further comprising executable instructions to notify the agent at the third computer whether an installment is due within a predetermined number of days.

7. The non-transitory machine-readable medium of claim 1, wherein the email message includes an embedded link to direct the person authorized by the insured to a web site associated with the premium financing entity.

8. The non-transitory machine-readable medium of claim 1, further comprising executable instructions to generate at the first computer an email message to the agent with an embedded link to facilitate the agent in obtaining status information associated with the PFA.

9. The non-transitory machine-readable medium of claim 1, further comprising executable instructions to automatically notify the agent via email at the third computer after the PFA was electronically signed by the person authorized by the insured and after the down payment amount was deducted from the bank account.

10. The non-transitory machine-readable medium of claim 1, further comprising executable instructions to provide the agent at the third computer with the option to delay booking of the PFA.

11. The non-transitory machine-readable medium of claim 1, further comprising executable instructions to verify at the first computer the bank account data associated with the insured.

12. The non-transitory machine-readable medium of claim 1, further comprising executable instructions to retrieve at either the first or the third computer data from a database corresponding to a quotation for premium financing for the insured to pre-populate at least a portion of the PFA.

13. The non-transitory machine-readable medium of claim 1, further comprising executable instructions to provide the insured at the second computer with the option to opt out of a payment selected by the agent.

14. The non-transitory machine-readable medium of claim 1, further comprising executable instructions to display at either the second or a fourth computer a summary review page to the person authorized by the insured, wherein the summary review page includes a link to an electronic representation of the PFA.

15. A non-transitory machine-readable medium having stored thereon a plurality of executable instructions to:
provide an agent with access to a premium finance agreement (“PFA”) on a first computer system of a premium financing entity before the PFA has been perfected;
display at a second computer one or more electronic payment options for the PFA to an agent representing a potential insured, wherein the one or more payment options include at least an option for electronic payment of a down payment for the PFA by the insured;
receive at the first computer data from the agent corresponding to a selected payment option;
display at the second computer summary information corresponding to the PFA to the agent;
determine at the first computer whether the agent electronically signed the PFA;
generate at the first computer an email message to the insured, wherein the email message includes data to facilitate the insured in accessing the computer system of the premium financing entity before the PFA has been perfected;
display at a third computer to the insured a set of data corresponding to the selected payment option selected by the agent;
receive at the first computer data associated with a name of a person signing the PFA on behalf of the insured;
prompt at either the third or a fourth computer the person signing the PFA to input bank account data, wherein the bank account data corresponds to a bank account that will be debited for at least the down payment for the PFA;
display, at either the third or the fourth computer, to the person signing the PFA, a confirmation of the down payment amount that will be deducted from the bank account provided by the person signing the PFA;
determine at the first computer whether the person signing the PFA electronically signed the PFA;
generate at the first computer an email to notify the person signing the PFA that the PFA has been completed if it is determined that the person signing the PFA electronically signed the PFA; and
electronically debit the bank account for at least the down payment amount.

16. The non-transitory machine-readable medium of claim 15, wherein the one or more payment options further comprises an option for electronic payment of scheduled installments of the PFA, and an option for electronic payment of both the down payment for the PFA and scheduled installments for the PFA.

17. The non-transitory machine-readable medium of claim 16, further comprising executable instructions to display at the second computer the down payment amount, a recurring installment amount, a number or remaining installments, and a first installment due date, when the agent selects the option for electronic payment of both the down payment for the PFA and the scheduled installments for the PFA.

18. The non-transitory machine-readable medium of claim 17, further comprising executable instructions to automatically generate at the first computer an email payment reminder to remind the insured of a remaining installment payment.

19. The non-transitory machine-readable medium of claim 15 further comprising executable instructions to generate at the first computer an email message to the agent with an embedded link to facilitate the agent in obtaining status information associated with the PFA.

20. The non-transitory machine-readable medium of claim 15, further comprising executable instructions to automatically notify the agent via email at the second computer after the PFA was electronically signed by the person signing the PFA and after the down payment amount was deducted from the bank account, the email notification including a unique confirmation number.

21. The non-transitory machine-readable medium of claim 15, further comprising executable instructions to provide the agent at the second computer with the option to delay booking of the PFA.

22. The non-transitory machine-readable medium of claim 15 further comprising executable instructions to verify at the first computer the bank account data associated with the insured by checking the validity of a transit/ABA number.
